(19) United States
(12) Patent Application Publication
(10) Pub. No.: US 2018/0336281 A1
(43) Pub. Date: Nov. 22, 2018

(54) Creator Aware and Diverse Recommendations of Digital Content

(71) Applicant: Adobe Systems Incorporated, San Jose, CA (US)

(72) Inventors: Natwar Modani, Bengaluru (IN); Ujjawal Soni, Chennai (IN); Gaurav Kumar Gupta, Bokaro Steel City (IN); Palak Agarwal, Firozabad (IN); Deepali Jain, Bengaluru (IN)

(73) Assignee: Adobe Systems Incorporated, San Jose, CA (US)

(21) Appl. No.: 15/598,193

(22) Filed: May 17, 2017

(51) Int. Cl. G06F 17/30; G06F 7/02

(52) U.S. Cl. CPC G06F 17/30867; G06F 7/026

(57) ABSTRACT

Techniques for creator aware and diverse recommendations of digital content are described. In one example, a digital medium environment is configured to allocate an amount of content creator access as part of a service. Based on this content creator access, recommendations of content are generated that prioritize content for recommendations based in part the amount of content creator access. Recommendations are generated further based on a representative diversity preference value that captures a level of interest of a consumer in different categories, resulting in a recommendation that is representatively diverse.

### BACKGROUND

Recommendation of content by online platforms has become an increasingly integral part of everyday life. Users, for instance, typically expect an online platform to provide personalized and relevant recommendations in a variety of contexts, such as media for consumption in an online service, articles suggested for purchase by an online retailer, search results by a search engine, and so on.

Accordingly, recommendation techniques have been developed to suggest items to particular users and have been employed in a wide range of scenarios, such as content-based filtering techniques and collaborative filtering techniques. By using a set of known preferences or history of a consumer, conventional recommendation techniques employed by recommendations systems filter content and make a prediction as to which items may be relevant to the consumer. Conventional recommendation techniques employed by recommendation systems, however, unfairly favor items that are already popular and fail to provide diverse recommendations. As such, conventional recommendation techniques employed by recommendation systems may discourage content creators from submitting content to online platforms. A new content creator, for instance, may submit content to an online platform but fail to receive adequate exposure, thereby discouraging the content creator from submitting additional content or even causing the content creator to leave the online platform entirely.

Conventional recommendation techniques employed by recommendation systems rely upon a history of consumer interaction with the new content. New content that lacks a history of consumer interaction, however, will not receive recommendations to consumers and thus there is no consumer interaction with which to build a history. In contrast, already popular content is highly recommended under conventional recommendation techniques employed by recommendation systems, leading to already popular content receiving even more consumer interaction and even more recommendations. Therefore, conventional recommendation techniques employed by recommendation systems give disproportionate recommendations that favor established content creators at the expense of new content creators.

Further, conventional recommendation techniques employed by recommendation systems do not consider the amount of diversity that a consumer may prefer to receive in recommendations. For example, conventional recommendation techniques employed by recommendation systems are unable to provide recommendations for content that is substantially different from content that a consumer is already known to like. When a consumer likes content from a first category, for instance, conventional recommendation techniques employed by recommendation systems only recommend content from the first category until it is also known that the consumer likes content from a second category. Thus, conventional recommendation techniques employed by recommendation systems may lack an ability to accurately provide diverse recommendations.

### SUMMARY

Techniques and systems for creator aware and diverse recommendations of digital content are described. These techniques are usable by a digital content recommendation system of a computing device (e.g., locally or “in the cloud”) to generate relevant and representatively diverse recommendations to consumers that also provide exposure to creators by considering a distribution of recommendations among different creators, which is not possible using conventional techniques which focus solely on the consumer.

The computing device, for instance, may employ a content creator access module to allocate an amount of content creator access (e.g., exposure) as part of a service. Based on this content creator access, the computing device then generates recommendations of content that prioritize content for recommendations based in part on a respective amount of content creator access. In this way, the computing device generates recommendations that account for a distribution of exposure among content creators, thereby supporting technical advantages over conventional techniques that rely solely on an analysis of the consumer.

In one example, the selection of content for inclusion in a recommendation is performed using the amount of content creator access and also by using a representative diversity preference value to ensure that the consumer receives a representatively diverse recommendation that captures a level of interest of the consumer in different categories. In this way, the techniques described herein may be used to increase the diversity of content within a recommendation beyond what can be achieved through conventional techniques, thereby increasing user acceptance of the recommendations.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ techniques for creator aware and diverse recommendations of digital content as described herein.

FIG. 2 depicts a system in an example implementation in which a digital content recommendation system of FIG. 1 is shown in greater detail as generating a digital content recommendation.

FIG. 3 is a flow diagram depicting a procedure in an example implementation in which an amount of content creator access is allocated to a content creator.

FIG. 4 is a flow diagram depicting a procedure in an example implementation in which a representative diversity preference value is determined for a recommendation request.

FIG. 5 is a flow diagram depicting a procedure in an example implementation in which content is selected for inclusion in a recommendation and a recommendation is created.

FIG. 6 is pseudo-code depicting an example implementation in which content is selected for inclusion in a recommendation and a recommendation is created.

FIG. 7 is pseudo-code depicting an example implementation in which content is selected for inclusion in a recommendation and a recommendation is created.

FIG. 8 illustrates an example system including various components of an example device that can be implemented as any type of computing device as described and/or utilize with reference to FIGS. 1-7 to implement embodiments of the techniques described herein.

### DETAILED DESCRIPTION

Overview

Conventional recommendation techniques, in an attempt to maximize user acceptance of recommendations, rely and operate solely on the basis of relevance of digital content to the consumer. However, in a two-sided platform, users can have two personas: consumers who like relevant and diverse recommendations, and creators who would like to receive exposure for their creations. Conventional techniques entirely overlook the creators of content. However, if new creators do not get adequate exposure, these new creators tend to leave the platform providing the recommendations. Consequently, less content is generated, resulting in lower consumer satisfaction. Thus, conventional recommendation techniques are unable to adequately serve recommendations in two-sided platforms where users are both the creators and consumers of content.

Accordingly, techniques for creator aware and diverse recommendations of digital content are described. In one example, a digital content recommendation system includes a content creator access module and a representative diversity module. The content creator access module is configured to allocate an amount of content creator access to a content creator, which is not possible using conventional techniques that do not consider the impact of recommendations on content creators. The allocation is performed by determining an amount of exposure for the content creator (e.g., a “fair” amount) based on a quantity and a quality of the content creator's work, and comparing the ‘fair’ amount of exposure to an amount of exposure already received by the content creator. The representative diversity module is configured to determine a representative diversity value that indicates a preference for each of multiple categories of content to be included within the recommendation. The determination is performed by the system through analyzing a consumers history of interaction with content to infer preferences, and supplementing the inferred preferences from global preferences taken as an average of the preferences of all consumers.

The digital content recommendation system then processes the amount of content creator access and the representative diversity value to re-rank or adjust content recommendations that are based on relevance to the consumer. In this way, the digital content recommendation system may provide recommendations that improve exposure distribution across creators without unduly affecting the relevance of recommendations provided to the consumers, which leads to increased creation of content and increased consumer acceptance of the recommendations.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Terminology Examples

Example descriptions or explanations of certain terms as used herein are set forth below. Each term is applicable to one or more, but not necessarily all, embodiments that are presented herein. Some terms are further described using one or more examples.

“Creative Capital” refers to a content creator's contribution to a content platform. The creative capital of a content creator incorporates both a quality and a quantity of the content creator's content, such that all contributions to the content platform will increase the creative capital and high quality content will increase the creative capital by a higher amount than low quality content. The creative capital of a content creator is dynamic and varies with time, such that the creative capital will decrease over time if the content creator does not submit content to the content platform.

“Content Creator Access” refers to a content creator's access to having content recommended by a content platform. The content creator access of a content creator is dependent on the content creator's creative capital and an amount of exposure received by the content creator. The content creator access associated with a content creator is determined based on a comparison of an amount of exposure that is ‘fair’ in consideration to the amount of exposure already received. For example, a content creator that is deserving of additional exposure is assigned a higher amount of content creator access than a content creator that is not deserving of additional exposure.

A “Representative Diversity Preference” refers to a preference for each of multiple categories of content. The representative diversity preference may be specific to a particular user, such that the representative diversity preference indicates the user's preference for each of multiple categories of content. Further, a representative diversity preference is dynamic and varies based on observations of preference. In the case of a particular user, the representative diversity preference may change or update whenever an interaction between the user and content is observed.

Example Environment

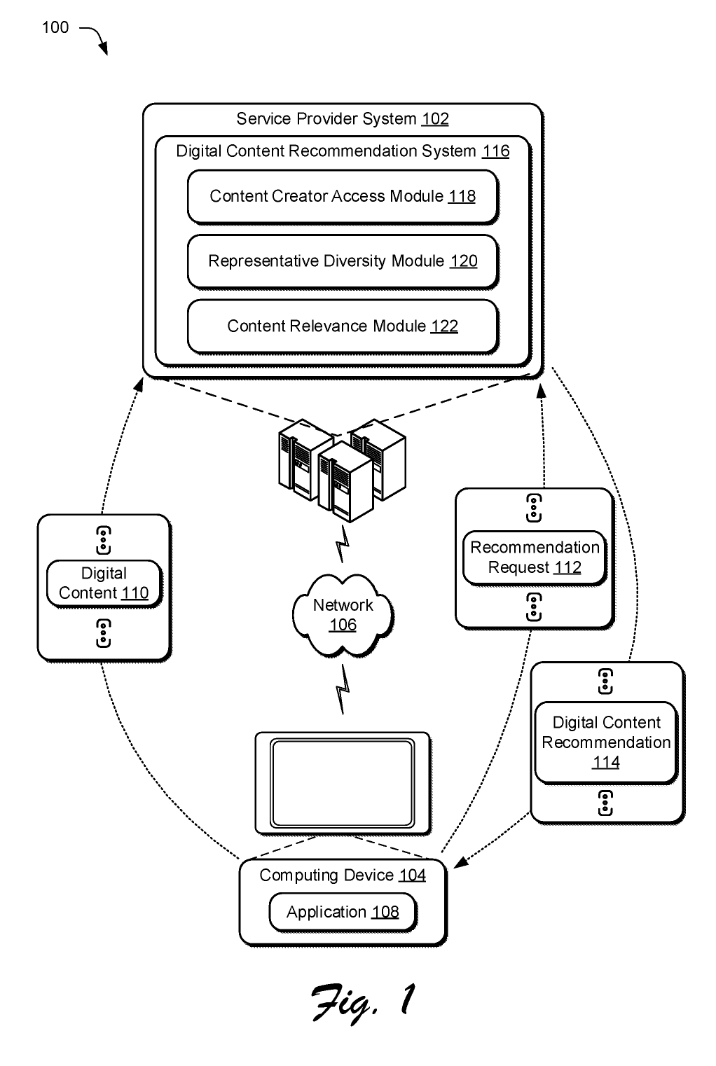

FIG. 1 is an illustration of a digital medium environment 100 in an example implementation that is operable to employ techniques described herein. The illustrated environment 100 includes a service provider system 102 and a computing device 104 that are communicatively coupled, one to another, via a network 106. Configuration of the computing device 104 as well as computing devices that implement the service provider system 102 may differ in a variety of ways.

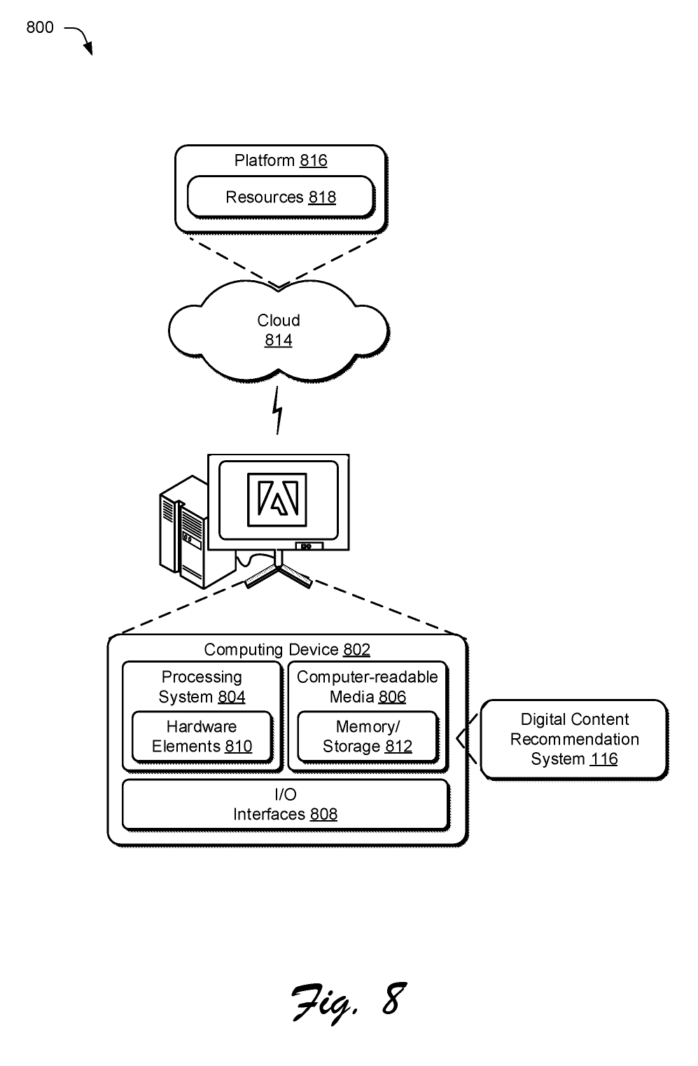

A computing device, for instance, may be configured as a desktop computer, a laptop computer, a mobile device (e.g., assuming a handheld configuration such as a tablet or mobile phone as illustrated), and so forth. Thus, a computing device may range from full resource devices with substantial memory and processor resources (e.g., personal computers, game consoles) to a low-resource device with limited memory and/or processing resources (e.g., mobile devices). Additionally, although a single computing device is shown, the computing device may also be representative of a plurality of different devices, such as multiple servers utilized by a business to perform operations “over the cloud” as illustrated for the service provider system 102 and as described in FIG. 8.

The computing device 104 is illustrated as including an application 108. The application 108 is implemented at least partially in hardware of the computing device 104 to implement corresponding functionality described herein. The various implementations enable a content creator to upload digital content 110 to the service provider system and/or enable a content consumer to send a recommendation request 112 to the service provider system 102 and receive a digital content recommendation 114 from the service provider system 102. The application 108 may also include a web browser which is operable to access various kinds of web-based resources (e.g., lists of actions, content, and services) from servers. The application 108 may also include an interface operable to access assets and the like from various resources, including asset stores and policy databases included within the service provider system 102.

In the illustrated example, the computing device 104 has created or obtained digital content 110, which is communicated via the network 106 to the service provider system 102. The service provider system 102 includes a digital content recommendation system 116 that is representative of functionality to manage creation and distribution of digital recommendations. The digital content recommendation system 116, for instance, may be part of an online service that is configured to maintain digital content and create digital content recommendations for users of the online service. In another example, the digital content recommendation system 116 is configured to curate digital content (e.g., to represent content submitted by a user as part on an online account), provide search results for digital content, and so forth. For instance, the service provider system 102 may have received a variety of digital content 110 from a multitude of different computing devices 104.

Examples of functionality of the digital content recommendation system 116 include a content creator access module 118, a representative diversity module 120, and a content relevance module 122. The content creator access module 118 is configured to allocate an amount of access to the service provider system 102 for a particular content creator whose digital content 110 is included in the service provider system 102. Conventional recommendation techniques do not account for a deserved amount of exposure associated with each particular content creator, and thus are unable to allocate an amount of access to the service provider system for a particular content creator. For example, a user associated with the computing device 104 has submitted digital content 110 to the service provider system 102 and is assigned an amount of access to the service provider system based on a quantity of the digital content 110, a quality of the digital content 110 (e.g., a “like”), and an amount of exposure received by the digital content 110 within the service provider system 102. The representative diversity module 120 is configured to determine a representative diversity preference value that indicates a preference for each of multiple categories of content. For example, a representative diversity preference value may be determined by observing the interaction between a user of the computing device 104 and the service provider system 102. The content relevance module 122 is configured to determine a relevance of digital content to a particular user, such as a user of the computing device 104.

The digital content recommendation system 116 is illustrated as receiving, via the network 106, a communication from the computing device 104 including a recommendation request 112. The computing device 104 that sends the recommendation request 112 may be a different computing device 104 than one that sends the digital content 110 and may even originate from the service provider system 102, itself. The digital content recommendation system 116 processes the recommendation request 112 to create a digital content recommendation 114 that is based on content creator access, representative diversity, and content relevance. The digital content recommendation 114 is then illustrated as being communicated back to the computing device 104 via the network 106. Although the content creator access module 118, the representative diversity module 120, and the content relevance module 122 are illustrated as being implemented “in the cloud” by the service provider system 102, this functionality may also be implemented in whole or in part locally by the computing device 104, e.g., as part of the application 108. Further discussion of this and other examples is included in the following sections and shown in corresponding figures.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in a variety of combinations and are not limited to the particular combinations represented by the enumerated examples in this description.

Digital Content Recommendation System

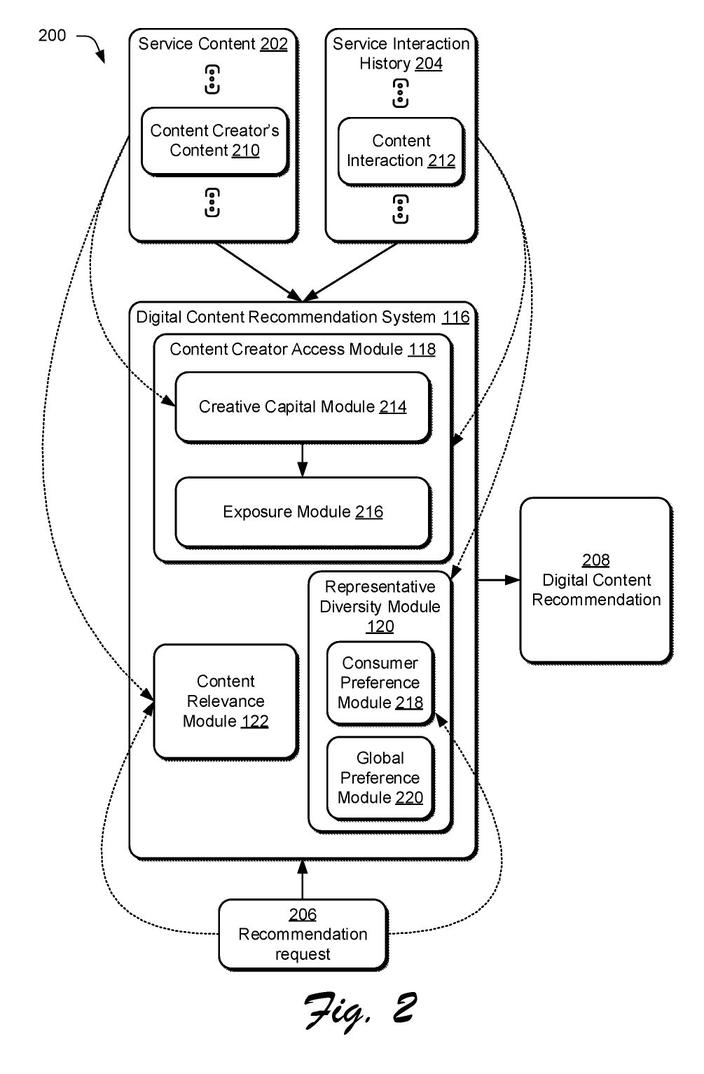

FIG. 2 depicts a system 200 in an example implementation in which the digital content recommendation system 116 of FIG. 1 is shown in greater detail as using service content 202, a service interaction history 204, and a recommendation request 206 to create a digital content recommendation 208 by utilizing the content creator access module 118, the representative diversity module 120, and the content relevance module 122. To begin, the digital content recommendation system 116 is illustrated as receiving service content 202 that includes content creator's content 210, and a service interaction history 204 that includes content interactions 212. The service content 202 may include a plurality of items of content creator's content 210 from a variety of different content creators. The service interaction history 204 may describe a variety of content interactions 212 between users of the service provider system 102 and the service content 202. A content interaction 212 describes a specific interaction between a user and an item of content creator's content 210, for instance the user viewing or appreciating the item of content creator's content 210.

The service content 202 and the service interaction history 204 are processed by the content creator access module 118 to allocate an amount of content creator access to a content creator. The content creator access module 118 includes a creative capital module 214 and an exposure module 216 that determine a ‘fair’ amount of content creator access associated with the content creator. The amount of content creator access may be determined in a variety of ways. In some implementations, an amount of content creator access is determined for each content creator associated with the service provider system, and in some implementations the amount of content creator access is pre-computed prior to receiving a recommendation request 206.

The creative capital module 214 is representative of logic implemented at least partially in hardware (e.g., as a processing system and computer-readable storage medium, integrated circuit, and so on as described in relation to FIG. 8) to assign a creative capital score to each respective content creator that represents the content creator's contribution to the service provider system 102. The creative capital of a content creator is a dynamic value that varies with time, and incorporates both a quality and a quantity of the content creator's content 210 that is associated with the content creator. The quantity of the content creator's content 210 is determined by examining the service content 202, while the quality of the content creator's content 210 is determined by analyzing the service interaction history 204. Specifically, the quality of the content creator's content 210 may be inferred by analyzing any content interactions 212 that are associated with the particular content creator.

The exposure module 216 is representative of logic implemented at least partially in hardware (e.g., as a processing system and computer-readable storage medium, integrated circuit, and so on as described in relation to FIG. 8) to evaluate the service interaction history 204 to determine an amount of content creator access associated with a particular content creator of the service provider system 102. To do so, the exposure module 216 first determines an amount of exposure already received by the particular content creator by evaluating the service interaction history 204 to determine a number of times the content creator's content 210 has been recommended to users of the service provider system 102. In some implementations, the determination of exposure already received further includes an analysis of a position in which each recommendation was presented. A ‘fair’ amount of exposure for a content creator is determined based on the content creator's creative capital. The ‘fair’ amount of exposure may be determined in a variety of ways, an example of which includes utilizing a sub-linear function to calculate an expected or deserved amount of exposure based on the content creator's creative capital. The ‘fair’ amount of exposure is utilized to assign each content creator an amount of content creator access that impacts how many recommendations made by the digital content recommendation system 116 include recommendations for the content creator's content 210. The amount of content creator access is assigned by comparing an amount of exposure that is “fair” in consideration to the amount of exposure already received, such that a content creator that is deserving of additional exposure is assigned a higher amount of content creator access than a content creator that is not deserving of additional exposure.

The digital content recommendation system 116 is further illustrated as receiving the recommendation request 206. The recommendation request 206 is a request for the service provider system 102 to create a digital content recommendation 208. For example, a user of the service provider system 102 may be utilizing the application 108 on the computing device 104 to connect to the service provider system via the network 106. In this example, the recommendation request 206 is a request for the service provider system 102 to create and communicate a digital content recommendation 208 to the computing device 104. Further, in this example, the recommendation request 206 may be generated by the application 108 or alternatively may be generated by the service provider system 102.

The recommendation request 206, along with the service interaction history 204, are processed by the representative diversity module 120 to determine a representative diversity value that indicates a preference for each of multiple categories of content to be included within a recommendation. The representative diversity module 120 includes a consumer preference module 218 and a global preference module 220 that are utilized in determining the representative diversity value to be associated with a particular recommendation request 206.

The consumer preference module 218 is representative of logic implemented at least partially in hardware (e.g., as a processing system and computer-readable storage medium, integrated circuit, and so on as described in relation to FIG. 8) to determine representative diversity preferences of a particular consumer associated with a particular recommendation request 206 by evaluating the service interaction history 204. The particular consumer may be identified based on information included within the recommendation request 206. For example, the recommendation request 206 includes information identifying a particular user of the service provider system 102 and the consumer preference module 218 locates within the service interaction history 204 the content interactions 212 that involve or are associated with the particular user. Located content interactions 212 are utilized to infer the consumer's preferences for specific categories of content.

The global preference module 220 is representative of logic implemented at least partially in hardware (e.g., as a processing system and computer-readable storage medium, integrated circuit, and so on as described in relation to FIG. 8) to determine an average or global diversity preference from among all consumers of the service provider system 102 by evaluating the service interaction history 204. The representative diversity module 120 may use the global diversity preferences to supplement the particular user's preferences. For example, if the service interaction history 204 includes few or no content interactions 212 involving a particular user identified in the recommendation request 206, the global diversity preferences may be used to ‘fill in the gaps’ in the user diversity preferences until more content interactions with the particular user occur. The user preferences may be weighted to increase as the amount of content interactions 212 associated with the particular user increases, and the global preferences may be ignored entirely after a threshold number of associated content interactions 212 exist.

The recommendation request 206, along with the service content 202, are processed by the content relevance module 122 to determine a relevance of each item of content creator's content 210 with respect to the recommendation request 206. For example, the recommendation request 206 may include information identifying a particular user of the service provider system 102, and the content relevance module 122 determines a relevance of the content creator's content 210 with respect to the particular user. A variety of techniques may be utilized to determine the relevance of content, such as by utilizing content-based filtering techniques, collaborative filtering techniques, hybrid filtering techniques, and so forth. Collaborative filtering techniques predict relevancy based on a history of content liked by other consumers. Content-based filtering techniques predict relevancy based on a similarity of features to content already liked by a consumer. Hybrid filtering techniques may recommend new items based on content filtering while recommending established items based on collaborative filtering. Additionally, the relevance of a particular item of content creator's content 210 may have a dynamic value that varies based on a positional importance of various positions in which the content 210 may be included within a recommendation.

The digital content recommendation system 116 processes the content creator access allocated by the content creator access module 118, the representative diversity value determined by the representative diversity module 120, and the relevance determined by the content relevance module 122 to rank each respective item of content creator's content 210. The digital content recommendation system 116 may select an item of content creator's content 210 for inclusion in a digital content recommendation 208 based on the ranking, and remove the selected content from the ranking list. The digital content recommendation system 116 continues selecting content 210 based on the ranking until a threshold amount of content 210 has been selected for inclusion in the digital content recommendation 208. Once a suitable amount of content has been selected for inclusion in the digital content recommendation 208, the digital content recommendation system 116 generates the digital content recommendation 208.

The digital content recommendation system 116 is illustrated as outputting the digital content recommendation 208. The digital content recommendation 208 may be output to a user device, rendered in a user interface of the computing device 104, and/or stored in a format capable of being later output or displayed. For instance, the digital content recommendation 208 may be output as a file capable of being manipulated by a user, output as a portion of a webpage, output for consumption by the application 108, stored by the service provider system 102, and so forth.

The following discussion describes techniques that may be implemented utilizing the previously described systems and devices. Aspects of the procedures may be implemented in hardware, firmware, software, or a combination thereof. The procedures are shown as sets of blocks that specify operations performed by one or more devices and are not necessarily limited to the orders shown for performing the operations by the respective blocks. In portions of the following discussion, reference will be made to FIG. 2.

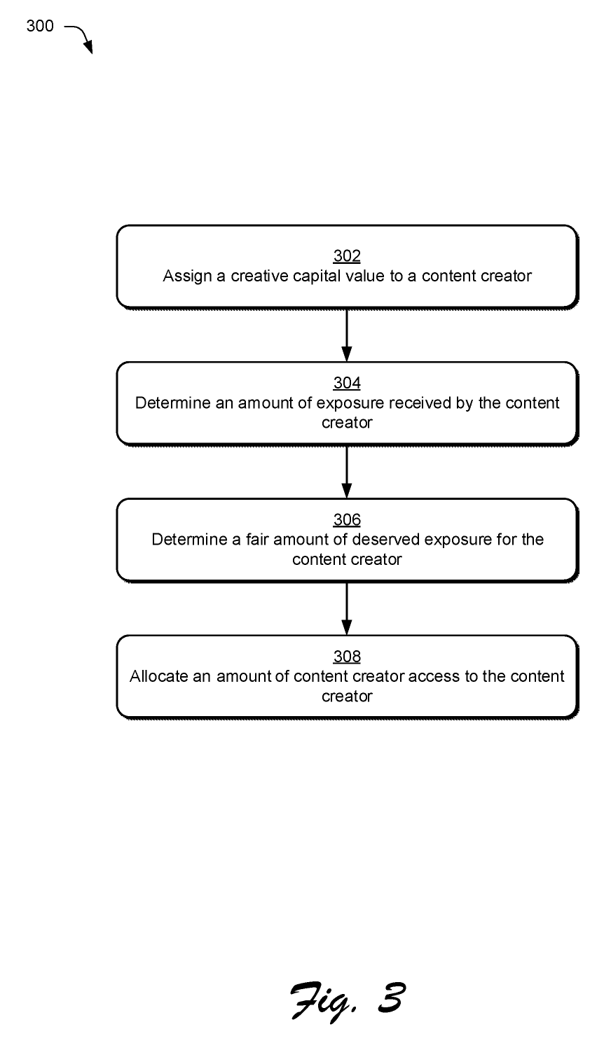

FIG. 3 illustrates an example procedure 300 for allocating content creator access. A creative capital score is assigned to each content creator that has submitted content 210 to the service provider system 102 (block 302). This may be performed, for instance, by the creative capital module 214. Creative capital represents the content creator's contribution to the service provider system 102. Content creators that create more content contribute more to the service provider system 102, however higher quality content contributes more than lower quality content. Thus, the creative capital score of a content creator incorporates both a quality and a quantity of the content creator's content 210. The quantity of the content creator's content 210 may be determined directly from the number of items of content creator's content 210 that exist within the service content 202. The quality of the content creator's content 210 may be estimated from a popularity of the content 210, which can be captured by a number of times users of the service provider system 102 have viewed the content 210 and a number of times the users have appreciated or ‘liked’ the content 210. Similarly, an indication of lack of appreciate or ‘dislike’ may indicate an unpopularity of the content 210. The creative capital score is dynamic and varies with time, so a creator that is inactive for a duration has their creative capital score decrease.

In some implementations, the creative capital score ‘Cᵤ’ is assigned according to the following function of time ‘t’:

Cᵤ(t)=γ*Cᵤ(t−1)+ωₚ*Δnₚ(t)+ωₐ*Δnₐ(t)+ωᵤ*Δnᵤ(t)

A creative capital ‘C’ of a content creator ‘u’ at a time ‘t’ is a function of the content creator's creative capital at a time ‘(t−1)’ and the capital earned in the period from (t−1) to ‘t’. A decay parameter ‘γ’ controls the amount of creative capital that a content creator loses over time, and decays the content creator's previously accumulated creative capital at the time (t−1) to ensure that newer content has a greater weight than older content. The weights ‘ωₚ’, ‘ωₐ’, and ‘ωᵥ’ are respective weights for each project ‘nₚ’ (e.g. content 210), appreciation ‘nₐ’, and view ‘nᵥ’. For example, if an administrator of the service provider system 102 values a quantity of submitted work more highly than a quality of submitted work, ωₚ may be set to have a higher value than ωₐ and ωᵥ. ‘Δnₚ’ is the number of projects or content created by the particular content creator between the time (t−1) and the time t, while ‘Δnₐ’ and ‘Δnᵥ’ are the number of appreciations and views, respectively, of the content in the time period of (t−1) to t.

An amount of exposure ‘Aᵤ’ received by each content creator ‘u’ is determined (block 304). This may be performed, for instance, by the exposure module 216. The amount of exposure already received by a particular content creator is determined by evaluating the service interaction history 204 to determine a number of times the content creator's content 210 has been recommended to users of the service provider system 102. In some implementations, a positioning of the recommendations when displayed to users affects the amount of exposure generated by the recommendation. As an example, an item of content 210 that is located first in a recommendation generates more exposure than an item of content 210 that is located second in the same recommendation. The positioning of a recommendation may include where on a display device the item of content is displayed as a part of the recommendation, whether a window containing the recommendation is ‘in-focus’ on the display device (i.e. not minimized and not obscured by another window on the display device), whether scrolling is performed to view the item of content within the recommendation, and so forth. In some implementations, the positional value ‘pv’ of a recommendation rank ‘k’ is determined according to the following function:

$$p v ( k ) = {e}^{- \frac{k - 1}{45}}$$

A ‘fair’ amount of deserved exposure is determined for each content creator (block 306). This may be performed, for instance, by the exposure module 216. To ensure that the exposure of a content creator is ‘fair,’ and to avoid the ‘rich-get-richer’ scenario of conventional collaborative filtering techniques, a desired exposure for a content creator is determined based on a sublinear function of the content creator's creative capital score. By using a sublinear function there is an incentive for content creators to continue contributing high quality content, however there is also an incentive for new content creators to contribute content since content creators with a high creative capital score do not monopolize all recommendations.

In some implementations, the deserved exposure ‘Eᵤ’ of a content creator ‘u’ is assigned according to the following function:

Eᵤ=θ*Cᵤ^{α}

The value ‘α’ is between 0 and 1, and ensures that allowed exposures increase with a content creator's creative capital while simultaneously giving fair opportunity of exposure to emerging creators as well. In some preferred implementations, α=0.75. The normalization factor ‘θ’ is a value such that ΣEᵤ=1, which results in the deserved exposure Eᵤ for a particular content creator being represented as a fraction of the total exposure available to all content creators.

An amount of content creator access is allocated to each content creator. (block 308). This may be performed, for instance, by the content creator access module 118. A content creator's received exposure Aᵤ is compared to the content creator's deserved exposure Eᵤ. Content creators with Aᵤ<Eᵤ receive a higher amount of content creator access that results in increased amounts of recommendations, while content creators with Aᵤ>Eᵤ receive a lower amount of content creator access that results in decreased amounts of recommendations.

Whether a distribution of exposures among content creators is fair may be evaluated by considering the fractional exposure provided to content creators (by normalizing across all content creators) and exposure distributions as probability distributions over the content creators. The fairness of the distribution of exposures among different content creators within the recommendation system ‘F’ is defined as an inverse of the Jensen-Shannon Divergence (“JS-Divergence”) between the received exposures Aᵤ and the desired exposure Eᵤ of a content creator:

$$F = \frac{1}{JSD ( E \vert \vert A )}$$

A low value of JS-Divergence means that the actual exposure distribution is close to the desired exposure distribution and that the system is fair. A high value of JS-Divergence implies that the actual exposure distribution is significantly different than the desired exposure distribution and that the system is not fair.

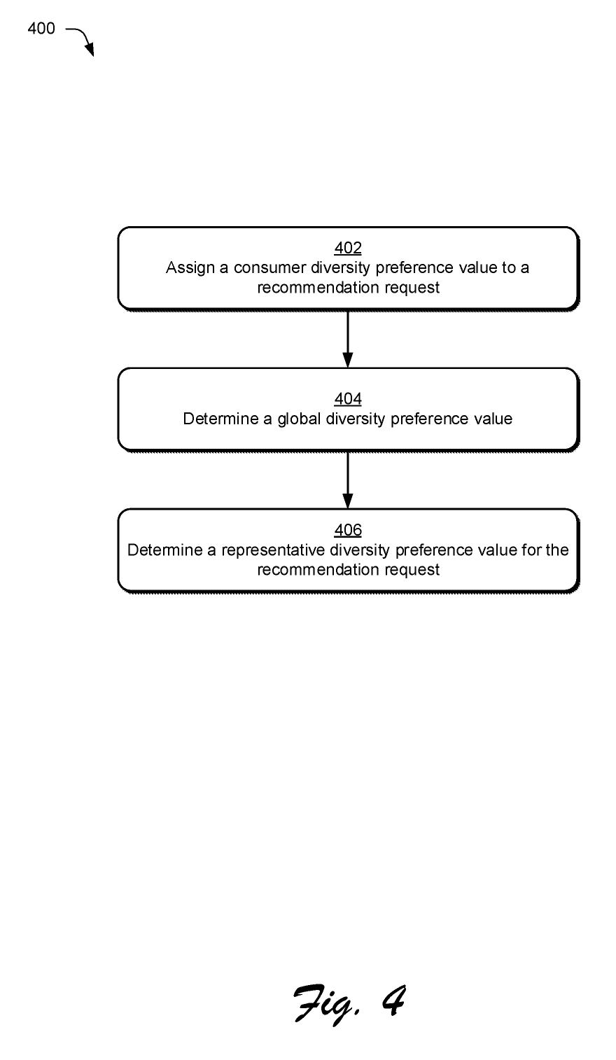

FIG. 4 illustrates an example procedure 400 for determining a representative diversity value. A representative diversity value indicates a preference for each of multiple categories of content. The representative diversity value is used to allocate an amount of exposure to be given to content from a particular category based on an interest in the particular category.

A consumer diversity preference value is assigned that is associated with a particular recommendation request (block 402). This may be performed, for instance, by the consumer preference module 218. The consumer diversity preference value is specific to a particular user of the service provider system 102. The particular user associated with a particular recommendation request may be identified, for instance, through information included in the recommendation request 206 that identifies the particular user, through an association between the particular user and a particular computing device 104, through credential information used to access the service provider system 102, and so forth. Consumer diversity preferences may be inferred according to content that the user has viewed and/or appreciated. For example, the service interaction history 204 may include content interactions 212 that involve the user or are otherwise associated with the user. Further, a degree of certainty in the inferred consumer diversity preference value may increase as a number of observations of the user increases. For example, as more content interactions 212 associated with the user are stored in the service interaction history 204, the consumer preference module 218 may have an increasing confidence in the consumer diversity preference value.

Next, a global diversity preference value is determined (block 404). This may be performed, for instance, by the global preference module 220. The global diversity preference value is determined from all content interactions 212 included in the service interaction history 204, irrespective of users being associated with the content interactions 212. Alternatively, the global diversity preference value may be determined based on a specific subset of consumers, such as a designated focus group created for the purpose of evaluating average diversity preferences.

Once the consumer diversity preference value and the global diversity preference value have been ascertained, a representative diversity value is determined (block 406). This may be performed, for instance, by the representative diversity module 120. Newer users of the service provider system 102 have seen and/or appreciated few objects of content creator's content 210, and thus inferring a new user's diversity preferences is likely to be inaccurate. Accordingly, the representative diversity value is a weighted average of the consumer diversity preference value and the global diversity preference value. The weighting is based on the number of observations available for the consumer, such that as more data exists about the consumer's preference the weights shift in favor of the consumer's diversity preference value.

The representative diversity value may be determined according to the following function:

E_{g}(u)=β*(λᵤp_{g}^{u}+(1−λᵤ)G_{g})

where ‘E_{g}(u)’ is the exposure fraction allocated to category ‘g’ for consumer ‘u’, ‘p_{g}^{u}’ is the estimated preference of consumer u for category g, and ‘G_{g}’ is the global preference for category g. The degree of certainty ‘λᵤ’ is the degree of certainty about the estimate of the consumer u's preferences such that 0≤λ≤1. Thus, λᵤ is a function of the amount of data available about consumer u's preferences. A new user begins with λᵤ=0, and as data is accumulated λᵤ increases and eventually saturates with λᵤ=1. Further, ‘β’ is a normalizing factor to ensure that Σ_{g}E_{g}(u)=1.

A diversity compliance of the digital content recommendation system 116 may be determined for a particular consumer ‘u’ as an inverse of the JS-Divergence of the desired exposure distribution for the categories ‘E^{c}’ and the actual exposure distribution ‘A^{c}’ for that consumer:

$$DC ( u ) = \frac{1}{JSD ( {E}^{c} ( u ) \vert \vert {A}^{c} ( u ) )}$$

Further, a global diversity compliance of the digital content recommendation system 116 may be defined as:

$$GDC = {\sum }_{u} \{ W ( u ) * DC ( u ) \} / {\sum }_{u} W ( u )$$

where ‘W(u)’ is the importance of a consumer ‘u’, which is taken as the sum of the positional value of all exposures provided to the user u.

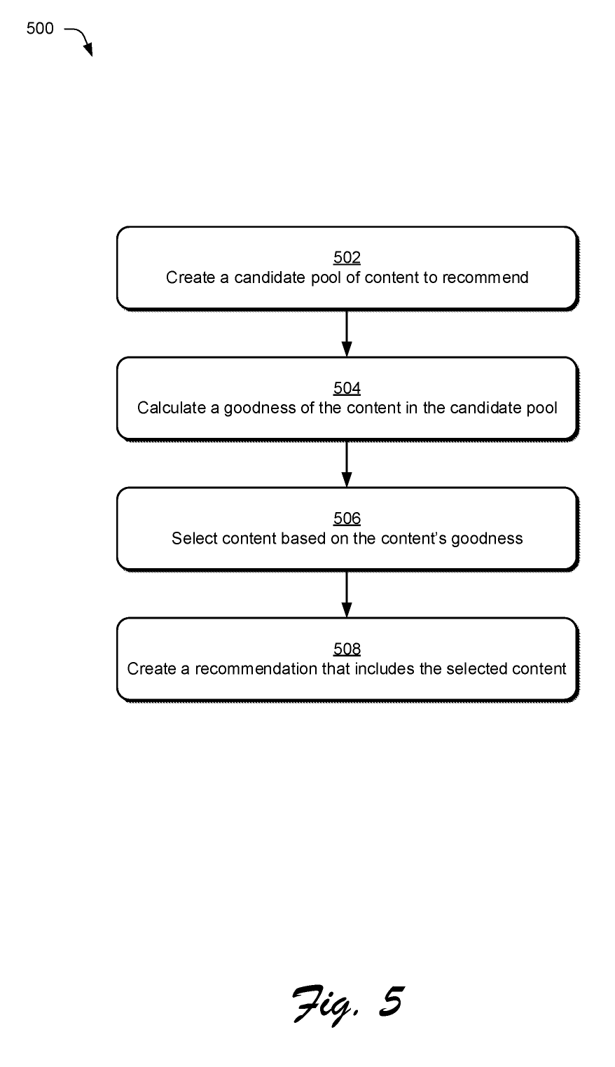

FIG. 5 illustrates an example procedure 500 for generating a digital content recommendation. A candidate pool of content for inclusion in a digital content recommendation is created (block 502). This may be performed, for instance, by the digital content recommendation system 116. The candidate pool of content may include the entirety of the service content 202, or alternatively may include only a subset of the service content 202. For instance, the candidate pool may include only content creator's content 210 that is above a threshold rating of relevance as determined by the content relevance module 122. If the candidate pool includes fewer items of content creator's content 210 than are to be included in the digital content recommendation 208, the candidate pool may be expanded to include content creator's content 210 that is below the threshold rating of relevance. In the case that the candidate pool of content must be expanded to include content creator's content 210 that has a relevance rating of 0 for the consumer, specific items of content 210 may be selected for inclusion based on global popularity ratings of the specific items of content 210. A global popularity rating of an item of content is the average of all observed ratings for the content from among all users of the service provider system 102.

Further, the initial candidate pool may be reduced based on predicted ratings of content 210 prior to determining relevance ratings for a particular consumer. The initial candidate pool may be limited, for instance, to a threshold number of items of content that have high predicted ratings, may be limited to include only items with a predicted rating above a threshold amount, or may be limited to include only items with a non-zero predicted rating. This is done to reduce the computational complexity and cost associated with processing every item of content creator's content 210 contained within the service content 202.

A goodness value is calculated for each item of content in the candidate pool (block 504). This may be performed, for instance, by the digital content recommendation system 116. A goodness value is the product of content's relevance rating and the content's ‘deservedness’ of receiving a recommendation. The deservedness of content is both a measure of how under-served the creator of the content would be if a recommendation is given for the content 210, and a measure of how under-served a category containing the content would be if a recommendation is given for the content 210.

The goodness value ‘G_{u,i}’ of content may be determined according to the following function:

G_{u,i}=r_{u,i}*V_{F}(c(i))*V_{D}(g(i))

where ‘V_{F}(c(i))’ is a value of allocating a recommendation to the creator of the content ‘i’, ‘V_{D}(g(i))’ is the value of allocating a recommendation to the category that the content i belongs to, and ‘r_{u,i}’ is the relevance rating of the content i to the user ‘u’. The allocation values V_{F} and V_{D} may be determined using the following greedy algorithm:

$${V}_{u} = {E}_{u} * \frac{( {\sum }_{v} {A}_{v} ( t - 1 ) + r ( t ) )}{( {A}_{u} ( t - 1 ) + r ( t ) )}$$

where ‘r(t)’ represents a particular slot within a recommendation. When calculating the allocation value V_{F} (the value of allocating a recommendation to a content creator in view of the distribution of recommendations among content creators), ‘Eᵤ’ is the deserved total exposure of the content creator and ‘Aᵤ’ is the amount of exposure received by the content creator. When calculating the allocation value V_{D} (the value of allocating a recommendation to a category in view of a desired amount of category diversity), ‘Eᵤ’ is the deserved total exposure of the category and ‘Aᵤ’ is the amount of exposure received by the category.

Content is selected for inclusion in a digital content recommendation based on the content's goodness value (block 506). This may be performed, for instance, by the digital content recommendation system 116, and may utilize a deterministic strategy or a probabilistic strategy. With the deterministic strategy, content is assigned to receive a recommendation based on a highest goodness value. With the probabilistic strategy, content is assigned to receive a recommendation by randomly selecting content from the candidate pool with a probability of selection for each item of content corresponding to the items goodness value. For example, under the probabilistic strategy, the goodness value of each item of content may be normalized against the total goodness values of all content in the candidate pool, and the probability of selection for an item of content is the contents normalized goodness value. Utilizing either the deterministic or the probabilistic strategy, if more than one item of content is wanted for a particular recommendation then the selected content is removed from the candidate pool and the process is iteratively repeated until a desired amount of content has been selected.

Once content has been selected for inclusion in a recommendation, a digital content recommendation is created that includes the selected content (block 508). This may be performed, for instance, by the digital content recommendation system 116. The digital content recommendation may be output to a user device, rendered in a user interface of a computing device 104, and/or stored in a format capable of being later output or displayed. For instance, the digital content recommendation may be output as a file capable of being manipulated by a user, output as a portion of a webpage, output for consumption by the application 108, stored by the service provider system 102, and so forth.

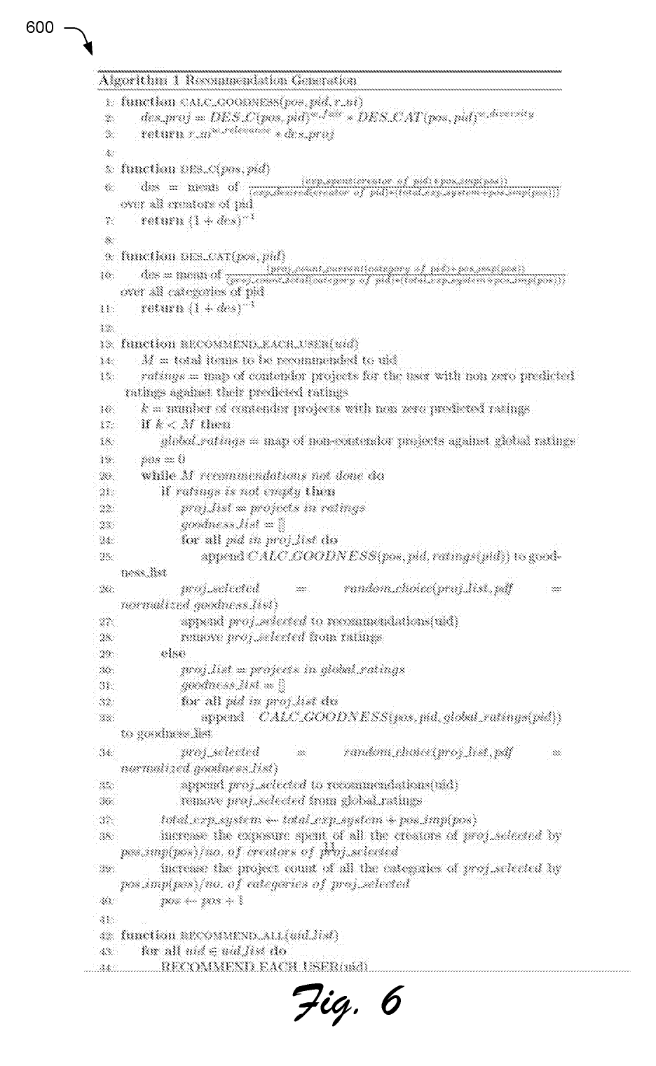

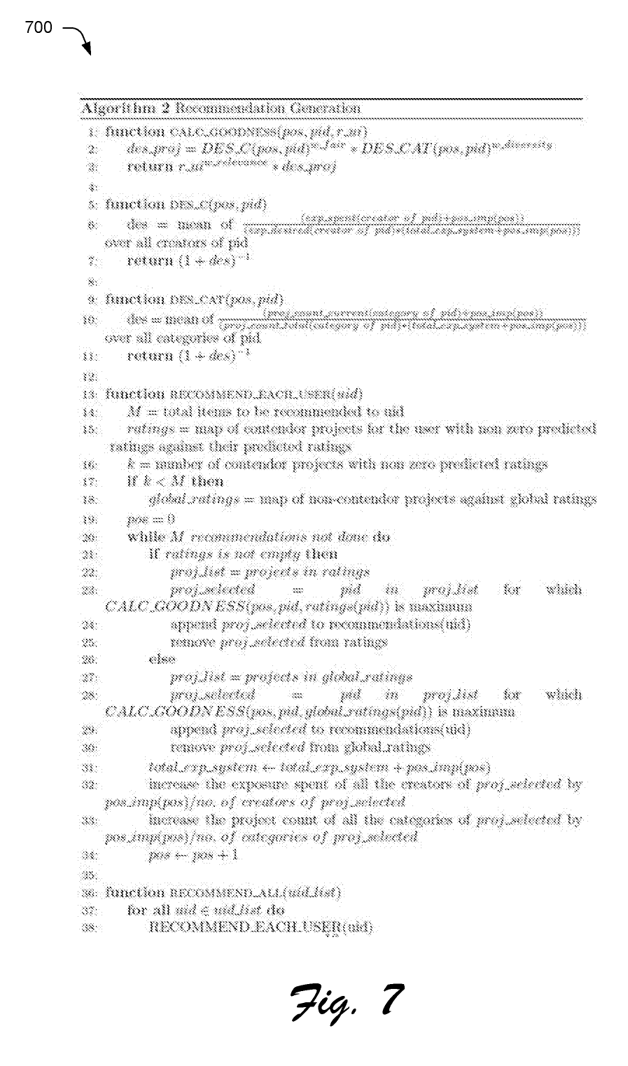

FIGS. 6 and 7 provide sets of pseudo-code as pseudo-code 600 and pseudo-code 700, respectively, to further illustrate example implementations of the processes described above.

Example System and Device

FIG. 8 illustrates an example system generally at 800 that includes an example computing device 802 that is representative of one or more computing systems and/or devices that may implement the various techniques described herein. This is illustrated through inclusion of the digital content recommendation system 116. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductors and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interfaces 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 may include applications and/or data that can be utilized while computer processing is executed on servers that are remote from the computing device 802. Resources 818 can also include services provided over the Internet and/or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to generate a recommendation involving digital content, a method implemented by at least one computing device, the method comprising:
allocating, by at least one computing device, an amount of content creator access as part of a service provider system by assigning a creative capital score to at least one content creator, the creative capital score representing an amount of contribution to the service provider system by the at least one content creator;
determining, by the at least one computing device, a representative diversity preference value based on user interaction data describing interaction between users of the service provider system and digital content available via the service provider system, the representative diversity preference value indicating a preference amount for each of multiple categories of the digital content;
generating, by the at least one computing device, a digital content recommendation based on the allocated amount of content creator access and the representative diversity preference value; and
outputting, by the at least one computing device, the digital content recommendation.

2. The method as described in claim 1, wherein the allocating the amount of content creator access is performed as a sub-linear function of the creative capital score assigned to the at least one content creator.

3. The method as described in claim 1, wherein the creative capital score is a time weighted value of a combination of a quantity of the digital content that is created by the at least one content creator and a quality of the digital content that is created by the at least one content creator.

4. The method as described in claim 3, wherein the quality of the digital content that is created by the at least one content creator is determined based on a number of user views of the digital content that is created by the at least one content creator via the service provider system and a quantity of user indications of appreciation of the digital content that is created by the at least one content creator.

5. The method as described in claim 1, wherein the request to generate the recommendation involving digital content includes a request to generate a recommendation involving digital content for a particular user, and the determining of the representative diversity preference value includes observing the particular user's interaction with the digital content available via the service provider system and determining the preference amount for each of the multiple categories based on observed interactions of the particular user with digital content associated with each of the multiple categories of the digital content.

6. The method as described in claim 5, wherein the determining the preference amount for each of the multiple categories is further based on a weighted average of the observed interaction of the particular user and general preferences associated with the service provider system, the weights are determined based on a number of observations included in the observed interactions.

7. The method as described in claim 1, wherein the generating the digital content recommendation includes comparing the amount of content creator access to an exposure value that represents a number of times that digital content created by the at least one content creator has been included in a digital content recommendation by the service provider system.

8. The method as described in claim 7, wherein the exposure value is further determined based on a location in which the digital content created by the at least one content creator was presented within each respective digital content recommendation.

9. The method as described in claim 1, further comprising determining, by the at least one computing device, a relevance of the digital content to a user associated with the digital content recommendation, and wherein the generating the digital content recommendation is further based on the relevance of the digital content.

10. In a digital medium environment to generate a recommendation involving digital content, a system comprising:
a content creator access module implemented at least partially in hardware of a computing device to allocate an amount of content creator access as part of a service provider system by assigning a creative capital score to at least one content creator, the creative capital score representing an amount of contribution to the service provider system by the at least one content creator;
a representative diversity module implemented at least partially in hardware of the computing device to determine a representative diversity preference value based on user interaction data describing interaction between users of the service provider system and digital content available via the service provider system, the representative diversity preference value indicating a preference amount for each of multiple categories of the digital content; and
a recommendation module implemented at least partially in hardware of the computing device to generate a digital content recommendation based on the allocated amount of content creator access and the representative diversity preference value.

11. The system as described in claim 10, wherein the allocating the amount of content creator access is performed as a sub-linear function of the creative capital score assigned to the at least one content creator.

12. The system as described in claim 10, wherein the creative capital score is a time weighted value of a combination of a quantity of the digital content that is created by the at least one content creator and a quality of the digital content that is created by the at least one content creator.

13. The system as described in claim 12, wherein the quality of the digital content that is created by the at least one content creator is determined based on a number of user views of the digital content that is created by the at least one content creator via the service provider system and a quantity of user indications of appreciation of the digital content that is created by the at least one content creator.

14. The system as described in claim 10, wherein the request to generate the recommendation involving digital content includes a request to generate a recommendation involving digital content for a particular user, and the determining of the representative diversity preference value includes observing the particular user's interaction with the digital content available via the service provider system and determining the preference amount for each of the multiple categories based on observed interactions of the particular user with digital content associated with each of the multiple categories of the digital content.

15. The system as described in claim 14, wherein the determining the preference amount for each of the multiple categories is further based on a weighted average of the observed interaction of the particular user and general preferences associated with the service provider system, the weights are determined based on a number of observations included in the observed interactions.

16. The system as described in claim 10, wherein the generating the digital content recommendation includes comparing the amount of content creator access to an exposure value that represents a number of times that digital content created by the at least one content creator has been included in a digital content recommendation by the service provider system.

17. The system as described in claim 16, further comprising a relevance module implemented at least partially in hardware of the computing device to determine a relevance of the digital content to a user associated with the digital content recommendation, wherein the generation of the digital content recommendation is further based on the relevance of the digital content, and wherein the exposure value is further determined based on a location in which the digital content created by the at least one content creator was presented within each respective digital content recommendation and the generating the digital content recommendation further includes ranking each of a plurality of items of the digital content as a function of: the amount of content creator access associated with a content creator associated with a respective said item and the exposure value associated with the content creator associated with the respective said item, and the relevance of the respective said item.

18. In a digital medium environment to generate a recommendation involving digital content, a system comprising:
means for allocating an amount of content creator access as part of a service provider system by assigning a creative capital score to at least one content creator, the creative capital score representing an amount of contribution to the service provider system by the at least one content creator;
means for determining a representative diversity preference value based on user interaction data describing interaction between users of the service provider system and digital content available via the service provider system, the representative diversity preference value indicating a preference amount for each of multiple categories of the digital content; and
means for generating a digital content recommendation based on the allocated amount of content creator access and the representative diversity preference value.

19. The system as described in claim 18, wherein the means for allocating the amount of content creator access includes means for allocating the amount of content creator access is performed as a sub-linear function of the creative capital score assigned to the at least one content creator.

20. The system as described in claim 18, further comprising means for determining a relevance of the digital content to a user associated with the digital content recommendation, wherein the means for generating the digital content recommendation is further based on the relevance of the digital content, and wherein the means for generating the digital content recommendation includes means for comparing the amount of content creator access to an exposure value that represents a number of times that digital content created by the at least one content creator has been included in a digital content recommendation by the service provider system.
